(19) United States
(12) Patent Application Publication
(10) Pub. No.: US 2012/0260094 A1
(43) Pub. Date: Oct. 11, 2012

(54) DIGITAL RIGHTS MANAGMENET USING ATTRIBUTE-BASED ENCRYPTION

(75) Inventors: Muhammad Asim, Eindhoven (NL); Milan Petkovic, Eindhoven (NL); Petrus Johannes Lenoir, Eindhoven (NL)

(73) Assignee: KONINKLIJKE PHILIPS ELECTRONICS N.V., EINDHOVEN (NL)

(21) Appl. No.: 13/516,503

(22) PCT Filed: Dec. 14, 2010
(86) PCT No.: PCT/IB10/55792

§ 371 Date: Jun. 15, 2012

(30) Foreign Application Priority Data
Dec. 18, 2009 (EP) 09179905.6

(51) Int. Cl. H04L 9/32; G06F 21/00

(52) U.S. Cl. 713/171; 726/1

(57) ABSTRACT

A data provider (1) for use in a digital rights management system comprises a data protector (2) for protecting data (20), using attribute-based encryption, in dependence on an access policy over a plurality of attributes. A license issuer (3) issues a license (17) comprising a representation of a set of usage rights (18), wherein the set of usage rights (18) is associated (19) with the data (20), for granting the usage rights (18) in respect of the data (20) to a plurality of entities (10) having attributes satisfying the access policy. A data receiver (10) comprises a data access subsystem (11) for accessing data, using attribute-based decryption, in dependence on a decryption key (16) associated with a set of attributes. The data receiver (10) further comprises a usage constraining subsystem (12) for constraining the access to the data (20), based on a license (17) comprising a representation of a set of usage rights (18) associated (19) with the data.

### FIELD OF THE INVENTION

The invention relates to digital rights management. The invention further relates to providing protected data and to accessing protected data.

### BACKGROUND OF THE INVENTION

Modern healthcare communication architectures tend to be open, interconnected environments: sensitive patient records no longer reside on mainframes physically isolated within a healthcare provider, where physical security measures can be taken to defend the data and the system. Patient files are rather kept in an environment where data is outsourced to or processed on partially trusted servers in order to allow de-centralized access for family doctors, medical specialists and even non-medical care providers. In order to allow sharing of records among different healthcare providers or with external parties, end-to-end security techniques facilitating data-centric protection can be employed: data is cryptographically protected and allowed to be outsourced or even freely float on the network.

DRM is an efficient solution for provisioning end-to-end security. In a DRM system, the content key is encrypted with the individual user's public key. Upon the reception of the protected content and DRM license comprising the encrypted content key, the content key is decrypted by using an individual's private key. The decrypted content key is then used to decrypt the content. This solution is presently used in entertainment scenarios such as music and video distribution. In healthcare scenarios, the access to the data is granted based on the attributes of the user, such as his role, affiliated department, group membership, and/or contextual information. For example a policy could be that the patient data is shared with the direct care providers only, where the direct care providers may consist of a number of different individuals. When different individuals request the PHR of the patient, the server has to determine which individuals satisfy the policy (based on their attributes), encrypt the content key with each individual's public key, and store and manage keys for each individual.

The paper “Security Attributes Based Digital Rights Management” by Jordan C. N. Chong et al, in Protocols and Systems for Interactive Distributed Multimedia, Lecture Notes in Computer Science, Volume 2515/2002, pp 339-352, presents a system for digital rights management by introducing multiple authorities that are responsible for issuing different certificates, i.e. identity certificate, attribute certificate and digital license. State of the art DRM systems operate on the identity certificate, which binds identity of a user with his/her public key. The user presents this certificate to the appropriate authority during a request for content. After successful evaluation of the identity certificate, a digital license is issued to the user which he/she can use to decrypt the content and the DRM client will enforce the digital rights outlined in the license. In the cited paper, a second level of control is introduced: attribute certificate. After the successful evaluation of both the identity and attribute certificate, the digital license is issued. The digital license contains the content key encrypted with the public key of the user, which can be decrypted by a DRM client using the corresponding private key.

### SUMMARY OF THE INVENTION

It would be advantageous to have an improved system for digital rights management. To better address this concern, a first aspect of the invention provides a data provider for use in a digital rights management system, comprising

a data protector for protecting data, using attribute-based encryption, in dependence on an access policy over a plurality of attributes; and

a license issuer for issuing a license comprising a representation of a set of usage rights, wherein the set of usage rights is associated with the data, for granting the usage rights in respect of the data to a plurality of entities having attributes satisfying the access policy.

Because the data is protected using attribute-based encryption, it is possible to control access to the data, using a policy over a set of the attributes. This way, it is not necessary to issue individually encrypted information to the users. Instead, the attribute-based encryption allows producing a single representation of the data which may be accessed by a plurality of users. This way, overhead, in terms of for example key management complexity and/or computational complexity, may be reduced. Moreover, the usage rights are controlled via the license. This makes it possible to set the usage rights for a group of users by means of a single license, because the license may be so constructed that it applies to all users who can access the protected data using their decryption key.

The data may comprise content. The data protector may comprise

a key encrypter for encrypting a representation of a content key, using attribute-based encryption, to obtain an encrypted content key; and

a content encrypter for encrypting the content, based on the content key.

Because of the attribute-based encryption, an attribute-based access policy can be enforced by means of encryption. Decryption keys satisfying the access policy can be used to decrypt the encrypted content key. Consequently, it is not necessary to encrypt the content key individually for each user who has access rights. Instead, the same encrypted content key can be used by individual users whose (unique) decryption keys satisfy the access policy. This makes the key management simpler.

Alternatively, the data protector may comprise a data encrypter for encrypting the data, using the attribute-based encryption. The data, or content, may be encrypted directly with attribute-based encryption. Encryption of a symmetric content key may be omitted.

The attribute-based encryption may comprise ciphertext-policy attribute-based encryption. Here, a ciphertext is associated with a policy over a set of attributes; the keys are associated with one or more of the attributes.

The license issuer may be arranged for including a representation of the access policy in the license. This way, it may be clear from the license what decryption keys may be used to access the data.

The system may comprise a key generator for generating a private key associated with a subset of the plurality of attributes. Such a private key can be distributed to a user to whom the subset of attributes applies. The user may then use the key to access the protected data. This allows providing attributes for example for different roles or associations of a user.

Another aspect of the invention provides a data receiver for use in a digital rights management system, comprising

a data access subsystem for accessing data, using attribute-based decryption, in dependence on a decryption key associated with a set of attributes; and

a usage-constraining subsystem for constraining access to the data, based on a license comprising a representation of a set of usage rights associated with the data.

Data receivers of this type can be given usage rights by means of the license, while restricting decryption capabilities according to an access policy. The decryption key associated with the set of attributes determines which data the receiver can access via attribute-based decryption. Since the same ciphertext can be decrypted by different receivers having keys associated with attributes satisfying the access policy, it is not necessary to encrypt the same information multiple times and then transmit these differently encrypted copies to individual receivers. This may reduce the computational overhead and may allow for easier data management. The usage-constraining subsystem may apply the usage rights prescribed in the license. This way detailed usage rights may be implemented.

The data may comprise content. The data access subsystem may comprise

a key decrypter for decrypting an encrypted representation of a content key, using attribute-based decryption, to obtain a decrypted content key; and

a content decrypter for decrypting the content, based on the decrypted representation of the content key.

In this system, the representation of the content key only needs to be encrypted once to enable decryption by a plurality of receivers having appropriate respective decryption keys. The content can be decrypted using the content key, which may be more efficient than attribute-based decryption. The key decrypter and content decrypter allow effective implementation of policy-based access control, because it combines the advantages of digital rights management and attribute-based encryption.

The data access subsystem may comprise a data decrypter for decrypting the data, using the attribute-based encryption. This is an alternative which may be implemented without using a separately encrypted content key.

The data provider and the data receiver set forth may be used in combination, wherein the data provider may provide the data which the data receiver may access.

Another aspect of the invention provides a license for use in a digital rights management system, comprising a representation of a set of usage rights, wherein the set of usage rights is associated with data protected using attribute-based encryption in dependence on an access policy over a set of attributes. This kind of license can be used in combination with attribute-based encryption to protect data. The license may be used for all receivers whose decryption key can be used to access the data. Alternatively, different licenses, defining different usage rights, may be provided to different receivers.

Another aspect of the invention provides a computer system comprising a data receiver as described above, for accessing personal health records provided by a data provider as described above.

Another aspect of the invention provides a method of providing data for use in a digital rights management system, comprising

protecting data using attribute-based encryption, in dependence on an access policy over a plurality of attributes; and

issuing a license comprising a representation of a set of usage rights, wherein the set of usage rights is associated with the data, for granting the usage rights in respect of the data to a plurality of entities having attributes satisfying the access policy.

Another aspect of the invention provides a method of receiving data for use in a digital rights management system, comprising

accessing data, using attribute-based decryption, in dependence on a decryption key associated with a set of attributes; and

constraining the access to at least part of the data, based on a license comprising a representation of a set of usage rights associated with the data.

Another aspect of the invention provides a computer program product comprising computer-readable instructions for causing a processor system to perform either one or both of the methods set forth.

It will be appreciated by those skilled in the art that two or more of the above-mentioned embodiments, implementations, and/or aspects of the invention may be combined in any way deemed useful.

Modifications and variations of the image acquisition apparatus, the workstation, the system, and/or the computer program product, which correspond to the described modifications and variations of the system, can be carried out by a person skilled in the art on the basis of the present description.

### BRIEF DESCRIPTION OF THE DRAWINGS

These and other aspects of the invention are apparent from and will be elucidated with reference to the embodiments described hereinafter. In the drawings,

FIG. 1 is a diagram of a digital rights management system.

FIG. 2 is a flow chart of a method of providing data;

FIG. 3 is a flow chart of a method of receiving data;

FIG. 4 is a diagram of a prior art DRM system; and

FIGS. 5 to 7 are diagrams of different architectures of a DRM system.

### DETAILED DESCRIPTION OF EMBODIMENTS

FIG. 4 illustrates an example of a general architecture of a digital rights management (DRM) system. Such a system is known from “Security, Privacy and Trust in modern data management”, Part IV, by M. Petkovic and W. Jonker (eds.); Spinger-Verlag, 2007. The system shown may comprise at least three components. A data server 401 which provides data 404, for example one or more information records/files (or content) that are protected by the DRM system. The protection may be achieved by encrypting the data 404 with a suitable encryption key (such as a content key). A license server 402 is arranged for providing the license 405 that gives access to the protected information 404 and that describes who/what (target) is allowed to access that information under what conditions (usage rights). The license 402 may contain an encrypted version of the content key. Such a license (or part of it) may be encoded in binary form, or as a string in an xml-based language such as Open Digital Rights Language (ODRL), or MPEG21, or another form of computer interpretable data.

A DRM client 403 may be allowed to access the protected data. The DRM client may comprise a tamper-resistant component that will act in compliance with policies and usage rights inherent to the DRM system and to policies and usage rights described in the license. The DRM client may be implemented on a device that is controlled by the user. The data server 401 and license server 402 may be under the control of the owner of the information. These two components may or may not be implemented on the same physical server device.

If a user wants access to a certain piece of information 404, the user may use a DRM client 403 to acquire the protected (e.g. encrypted) information record 404. The DRM client may also acquire the license 405 from the license server, as the compliant DRM client 403 would not access the information without it. Via a key management scheme, which may be specific for the DRM system, the DRM client 403 can find the decryption keys linked to the target information record 404, as mentioned in the license 405, to decrypt a content key. Such a key management scheme may comprise a hierarchy of encrypted keys, where the last key may comprise the content key and the other keys may be used to efficiently address and/or select the target (i.e., the user or users to whom the protected data is addressed). The content key can be used to decrypt the information record 404. The DRM client 403 may use the content key to decrypt the information record 404 if and only if all the conditions prescribed by the usage rights are met.

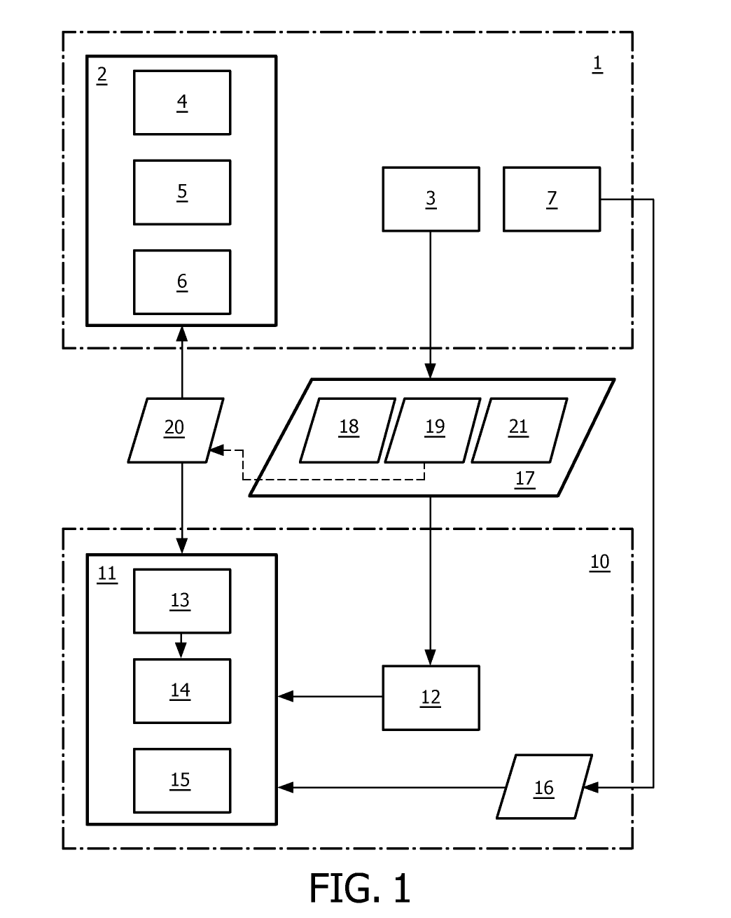

FIG. 1 shows a diagram of a digital rights management (DRM) system comprising a data provider 1 and a data receiver 10. The system may comprise a plurality of data providers 1 and/or a plurality of data receivers 10. For example, a centralized data repository may be implemented comprising a data provider 1. Such data may be obtained from the centralized data repository by any one of a plurality of data receivers 10. The data provider 1 may be connected to the data receiver 10 via a network. It is also possible that the data from the data provider 1 is stored in a separate database, or on a removable storage media, which may be accessed by the data receiver 10.

The data provider 1 may comprise a data protector 2 for protecting data 20, using attribute-based encryption, as will be explained hereinafter. This attribute-based encryption may be performed, in dependence on an access policy, over a plurality of attributes. The data provider 1 may further comprise a license issuer 3 for issuing a license 17 comprising a representation of a set of usage rights 18. This set of usage rights 18 may be associated with the data 20. For example, an association 19 may be included in the license 17. Such an association may comprise an identifier of the data or a universal resource locator (URL) of the data 20, for example. The license 17 may be used for granting the usage rights 18 in respect of the data 20. These usage rights may be granted to a plurality of entities 10 having attributes satisfying the access policy used by the data protector 2 for protecting the data 20. It is possible to grant the usage rights to a subset of the entities 10 having attributes satisfying the access policy used by the data protector 2.

The data provider 1 may use a content key encryption scheme. In this description, the data protected using such a content key encryption scheme is referred to as content. In such a case, the data protector 2 may comprise a key encrypter 4 for encrypting a content key, using attribute-based encryption, to obtain an encrypted content key. The data protector 2 may further comprise a content encrypter 5 for encrypting the content, based on this content key. The data protector 2 may encrypt multiple copies of the content key, using different encryption keys and/or policies, enabling decryption of the content key by different users and/or groups of users. The data may be encrypted once using the same content key.

In this example, a key management hierarchy of two levels (encrypted data and an encrypted content key) is described. However, this is not a limitation. Deeper hierarchies are also possible. Such hierarchies may be tree-based. Part of the hierarchy may relate to the target, and part of the hierarchy may relate to the content. Such hierarchies may be introduced for efficiency in key distribution and/or for efficiency in accessing (part of) the data.

Alternatively, the data provider 1 may comprise a data encrypter 6 for encrypting the data 20, using the attribute-based encryption. In such a case, no intermediate content key is needed.

The attribute-based encryption employed by the data protector 2, in particular by the content key encrypter 4 and/or the data encrypter 6, may be arranged for performing ciphertext-policy attribute-based encryption. Such encryption creates a ciphertext which can be decrypted using a decryption key associated with a set of attributes which satisfy some particular constraints defined by the access policy.

The license issuer 3 may be arranged for including a representation of the access policy 21 in the license 17. This allows the data receiver 10 to ascertain easily whether it has access to the data by evaluating the license. The data receiver 10 then does not need to process the data 20 in order to know if it can decrypt the data 20.

The data provider 1 may comprise a key generator 7 for generating a private key associated with a subset of the plurality of attributes. This private key may be a decryption key for an attribute-based encryption scheme such as ciphertext-policy attribute-based encryption. Such private keys may be distributed to the data receivers 10 in the system. For distribution of the keys, a private out of band channel may be used, however this is not a limitation.

The Figure illustrates an example data receiver 10 for use in the digital rights management system. In reality, more such data receivers may participate in the digital rights management system. The data receiver 10 may comprise a data access subsystem 11 for accessing the data 20 using attribute-based decryption. Such attribute-based decryption may be performed in dependence on a decryption key 16 associated with a set of attributes.

The data receiver 10 may further comprise a usage-constraining subsystem 12. Such a usage-constraining subsystem 12 may constrain the access to the data 20, based on the license 17. The license 17 may comprise a representation of a set of usage rights 18 associated with the data 20 via association 19. The usage-constraining subsystem 12 may enforce these usage rights 18, for example by blocking any actions which may violate the usage rights 18. Such a usage-constraining subsystem 12, as well as the data access subsystem 11 and/or decryption key 16, may be made tamper-resistant, to avoid easy circumvention of the usage rights 18.

As described above, the data 20 may comprise content and/or an encrypted content key. Such data may be accessed by a data access subsystem 11 which comprises a key decrypter 13 and a content decrypter 14. The key decrypter 13 may be arranged for decrypting the encrypted content key, using attribute-based decryption. This way, a decrypted content key is obtained. The content decrypter 14 may be arranged for decrypting the content, based on the decrypted content key. This latter decryption step performed by the content decrypter 14 may be based on symmetric key decryption, for example.

Alternatively, the data access subsystem 11 may comprise a data decrypter 15 for decrypting the data 20 directly, using attribute-based decryption.

The license 17 which may be used in the digital rights management system may comprise a representation of a set of usage rights 18, an association 19 of the set of usage rights with data 20 protected using attribute-based encryption in dependence on an access policy over a set of attributes. The license may further comprise a representation of an access policy 21 used in an attribute-based encryption step in the protection of the data 20.

The data may comprise one or more personal health records, for example. Different data items may be protected by encryption based on a different access policy. Moreover, different licenses may be associated with the different data items. More than one license may be associated with the same piece of data. Different licenses may be intended for different users, for example, or may be intended to be used during different time intervals. To this end, a license may comprise a description of a validity period. The data receiver 10 may be part of a computer system, for example a PC, which computer system may further comprise a user interface allowing a user to control the computer system, a display for displaying a representation of the data, a communications port for enabling communication via a wired or wireless network, and/or a reader and/or writer for handling removable storage media. The data and/or license may be delivered via a network and/or via a removable storage medium.

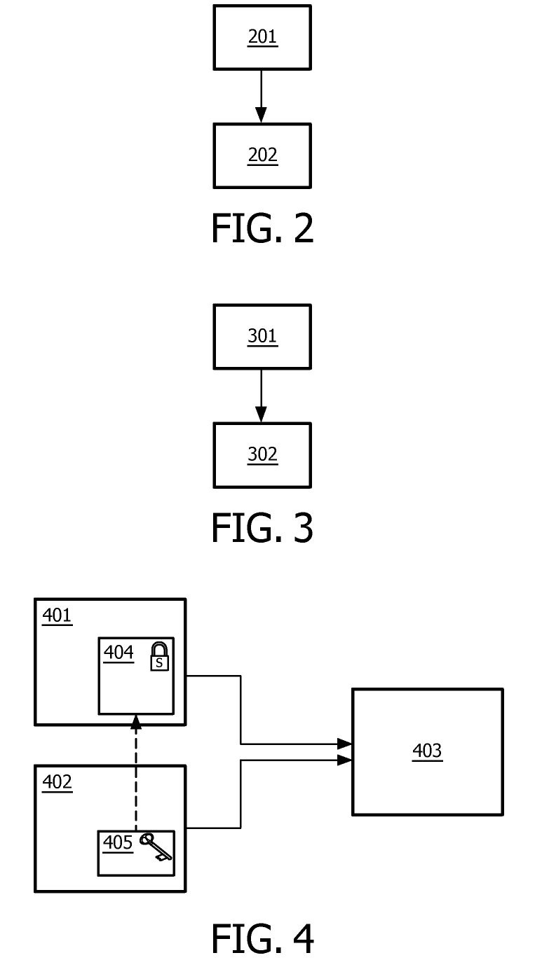

FIG. 2 illustrates a method of providing data for use in a digital rights management system. The method may comprise a step 201 of protecting data using attribute based encryption, in dependence on an access policy over a plurality of attributes. The method may further comprise a step 202 of issuing a license comprising a representation of a set of usage rights, wherein the set of usage rights is associated with the data, for granting the usage rights in respect of the data to a plurality of entities having attributes satisfying the access policy. The license may further comprise a representation of the access policy.

FIG. 3 illustrates a method of receiving data for use in a digital rights management system. The method may comprise a step 301 of accessing data using attribute based decryption, in dependence on a decryption key associated with a set of attributes. The method may further comprise a step 302 of constraining the access to at least part of the data, based on a license comprising a representation of a set of usage rights associated with the data. The license may further comprise a representation of the access policy. This representation of the access policy may be matched against the set of attributes, to verify whether the license is intended for use in combination with the set of attributes. If the set of attributes does not comply with the access policy, the method may comprise refusing to access the data and/or refusing to use the license.

These methods may be implemented by means of a computer program product comprising computer-readable instructions for causing a processor system to perform the respective method.

Privileges of users, reflected by access policies and usage rights, may change over time, even after the data has been encrypted. Such a change of privileges may be implemented by providing the receiver 10 with a new decryption key 16 associated with a different set of attributes. Also a new license may be provided. However, it is also possible that the same license can be used, in which case the decryption key 16 determines whether a particular license is valid for the receiver 10. For example, the license could be encrypted by means of attribute-based encryption, wherein the policy of the attribute-based encryption determines whether the license applies for a particular receiver 10, based on the receiver's decryption key 16.

Sharing and/or distributing of sensitive health information raises special problems with respect to access control. Access to data may be governed based on a user's attributes, e.g. user's role, affiliation with a department, etc.

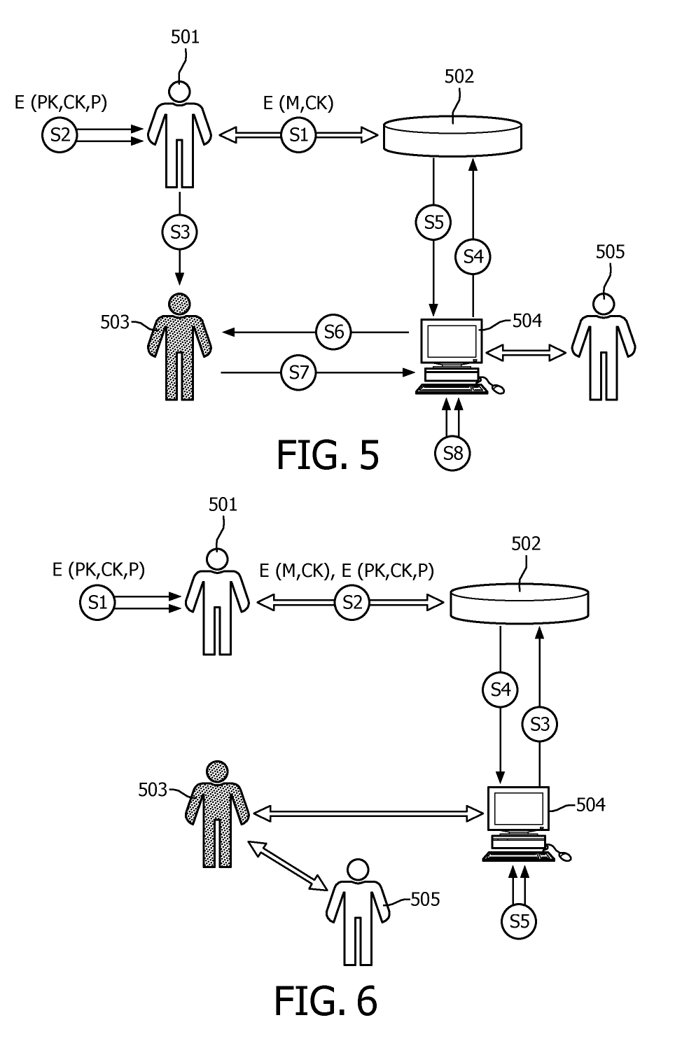

FIGS. 5, 6, and 7 illustrate examples of architectures of DRM systems. These architectures may be implemented using the data provider 1 and/or the data receiver 10 described in respect of FIG. 1. Also, the methods explained in respect of FIGS. 2 and 3 may be used in conjunction with any of these example architectures. Other architectures, not shown in the drawings, may also be realized using the products and methods set forth herein. In the Figures, similar process steps and objects have been labeled with the same reference numerals.

Referring to FIG. 5, in step S1, the data owner 501 encrypts his or her content, for example a personal health record, with a content encryption key CK, using any state of the art block cipher, such as advanced encryption standard (AES), etc., and stores it on a back-end service 502, such as a network-based data repository.

In step S2, the data owner 501 encrypts the content key CK with an access policy P over a set of attributes, which specifies with whom the data owner 501 is willing to share his/her content.

In step S3, the data owner 501 sends the encrypted content key CK and the policy P (i.e. E_{CP}_{_{—}}_{ABE}(CK), P) according to which the CK is encrypted to a trusted third party 503. In this example, the encryption scheme used is ciphertext-policy attribute-based encryption CP-ABE. However, this is not a limitation.

In step S4, a user 505 requests the content from the back-end service 502, via a client device or data receiver 504.

In step S5, the back-end service 502 sends the content to the data receiver 504. The data is sent in the encrypted form.

In step S6, the data receiver 504 requests a license from the trusted third party 503. The request may contain attributes of the user 505 and may also contain other information such as purpose of use and actions that the user wants to perform on the data.

After verification of the user attributes, and possibly other information, the trusted third party 503 may send the requested license to the DRM client in step S7. The license may contain the usage rights, encrypted content key and/or other information such as the issuer of the license.

In step S8, the DRM client device or data receiver 504 decrypts the content for the user and enforces the usage rights described in the usage license.

FIG. 6 illustrates another architecture. In the architecture shown in FIG. 6, in step S1, the data owner 501 encrypts his or her data (such as a PHR or content) with a content encryption key CK, using any state of the art block cipher such as advanced encryption standard (AES). In addition, the data owner 501 encrypts the content key CK using attribute-based encryption, according to an access policy P over a set of attributes, which specifies with whom the patient is willing to share his/her data, such as PHR or content.

In step S2, the data owner 501 stores the encrypted data along with encrypted license (which may contain the encrypted content key encrypted using ABE) on the back-end service 502. The trusted third party 503 provides the private decryption key associated with the attributes of user 505 to the data receiver 504, after the trusted third party 503 has verified the identity of the user 505.

In step S3, a data receiver 504 requests the data from the back-end service 502. In step S4, the back-end service 502 sends the encrypted data along with the license to the requesting data receiver 504. In step S5, the data receiver 504 decrypts the content key CK using the private key of user 505. Herein, it is assumed that the DRM client already has the private key (or keys) associated with the attributes of the user. This private key may have been issued by the trusted third party 503. The content key CK is then used by the data receiver 504 to decrypt the content. The DRM client enforces the usage rights described in the license.

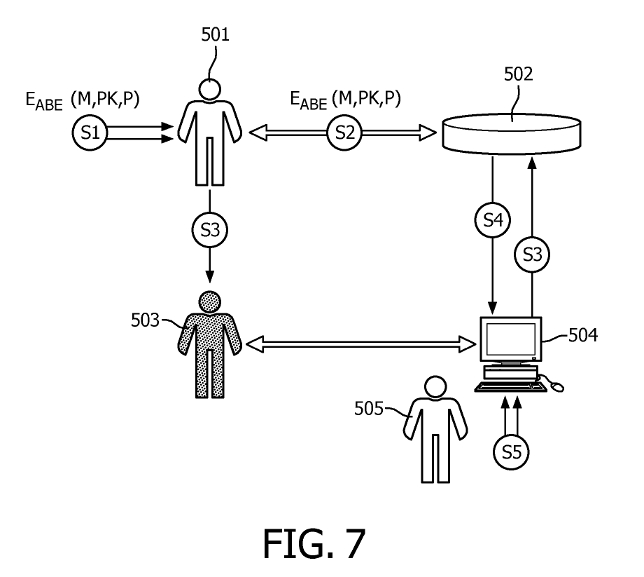

FIG. 7 illustrates an alternative architecture. In this architecture, the content may be encrypted directly using ABE.

In step S1 shown in FIG. 7, the data owner 501 encrypts his or her data (such as a personal health record or other content) directly using ABE, according to an access policy P over a set of attributes specifying with whom the data owner is willing to share his/her data.

In step S2, the data owner 501 stores the encrypted data and an associated protected license on the back-end service 502. As is the case for the other architectures, the license may be protected by means of a digital signature or by means of encryption or otherwise. The license may contain the policy according to which the data is encrypted, usage permissions with respect to the content, and/or some other information such as information about a signer of the certificate. The trusted third party 503 may provide the private key associated with the attributes of the user 505 to the data receiver 504, after the trusted third party 503 has verified the identity and attributes of the user 505.

In step S3, a user 505 requests the data from the back-end service 502 via a client device or data receiver 504. In step S4, the back-end service 502 sends the encrypted data and the license to the requesting data receiver 504. In step S5, the client device 504 decrypts the data using the decryption algorithm of the ABE and using the private key associated with the attributes of the user. The data receiver 504 enforces the usage permissions described in the license.

In the following, by way of example, possible structures of a license to be used with the digital rights management system are described. A license may comprise general information, such as issuer of the license, version number, and the like. The license may further comprise information about the target of the license (describing to whom the license is intended to give usage rights). Such target information may comprise an identifier of a target user or target device. Additionally or alternatively, the target information may comprise a policy over a plurality of attributes. In the latter case, the target information may indicate a group of users or data receivers, by means of a policy over the attributes of the respective members of the group. The license may further comprise a representation of a usage policy. Such usage policy may describe the usage rights granted to the target user(s) and/or data receiver(s). Depending on the particular protection scheme used, the license may comprise a content key encrypted using attribute-based encryption. Alternatively or additionally, the license may comprise a link or reference or identifier of the protected content. Such a link may also be omitted. In the latter case, the content may comprise an identifier of the applicable license(s).

A ciphertext-policy attribute-based encryption algorithm may comprise the following four main algorithms which may be run by the different actors in an encryption scheme.

Setup (1^{k}): The setup algorithm may have an implicit security parameter as an input. It may output the public parameters PK and a master key MK. This algorithm may be run by a trusted party.

Key Generation (MK, S): The key generation algorithm may take as an input the master key MK and a set of attributes S associated with the to-be-generated key. It may output a private key SK. This algorithm may be run by the trusted party.

Encrypt (PK, M, P): The encryption algorithm may take as input the public parameters PK, a message M, and a Policy P over a universe of attributes. The algorithm may encrypt M and produce a ciphertext C such that only a user that possesses a key associated with a set of attributes that satisfies the access policy P is able to decrypt the message. The message M may comprise the content key (CK) encrypted using CP-ABE. This algorithm may be run by the data owner.

Decrypt (C, SK): The decryption algorithm may take as an input the ciphertext C associated with an access policy P, and a private key SK, which is a private key associated with a set S of attributes. If the set S of attributes satisfies the access policy P, then the algorithm can decrypt the ciphertext and may return the decrypted message M. This algorithm may be run by the DRM client or data receiver. Such a data receiver may be controlled by an end user who may request access to the data. It could be a doctor, nurse, friend or family member of the data owner.

The data provider may comprise a medical data repository or server that provides health data in an access-controlled way. However, other applications, such as copyright protection, using online media distribution or removable storage media, are also possible.

It will be appreciated that the invention also applies to computer programs, particularly computer programs on or in a carrier, adapted to put the invention into practice. The program may be in the form of a source code, an object code, a code intermediate source and object code such as in a partially compiled form, or in any other form suitable for use in the implementation of the method according to the invention. It will also be appreciated that such a program may have many different architectural designs. For example, a program code implementing the functionality of the method or system according to the invention may be sub-divided into one or more sub-routines. Many different ways of distributing the functionality among these sub-routines will be apparent to the skilled person. The sub-routines may be stored together in one executable file to form a self-contained program. Such an executable file may comprise computer-executable instructions, for example, processor instructions and/or interpreter instructions (e.g. Java interpreter instructions). Alternatively, one or more or all of the sub-routines may be stored in at least one external library file and linked with a main program either statically or dynamically, e.g. at run-time. The main program contains at least one call to at least one of the sub-routines. The sub-routines may also comprise function calls to each other. An embodiment relating to a computer program product comprises computer-executable instructions corresponding to each processing step of at least one of the methods set forth herein. These instructions may be sub-divided into sub-routines and/or stored in one or more files that may be linked statically or dynamically. Another embodiment relating to a computer program product comprises computer-executable instructions corresponding to each means of at least one of the systems and/or products set forth herein. These instructions may be sub-divided into sub-routines and/or stored in one or more files that may be linked statically or dynamically.

The carrier of a computer program may be any entity or device capable of carrying the program. For example, the carrier may include a storage medium, such as a ROM, for example, a CD ROM or a semiconductor ROM, or a magnetic recording medium, for example, a floppy disk or a hard disk. Furthermore, the carrier may be a transmissible carrier such as an electric or optical signal, which may be conveyed via electric or optical cable or by radio or other means. When the program is embodied in such a signal, the carrier may be constituted by such a cable or other device or means. Alternatively, the carrier may be an integrated circuit in which the program is embedded, the integrated circuit being adapted to perform, or being used in the performance of, the relevant method.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A data provider (1) for use in a digital rights management system, comprising
a data protector (2) for protecting data (20), using attribute-based encryption, in dependence on an access policy over a plurality of attributes; and
a license issuer (3) for issuing a license (17) comprising a representation of a set of usage rights (18), wherein the set of usage rights (18) is associated (19) with the data (20), for granting the usage rights (18) in respect of the data (20) to a plurality of entities (10) having attributes satisfying the access policy.

2. The data provider (1) according to claim 1, wherein the data (20) comprises content and the data protector (2) comprises
a key encrypter (4) for encrypting a representation of a content key, using attribute-based encryption, to obtain an encrypted content key; and
a content encrypter (5) for encrypting the content, based on the content key.

3. The data provider (1) according to claim 1, wherein the data protector (2) comprises a data encrypter (6) for encrypting the data (20), using the attribute-based encryption.

4. The data provider (1) according to claim 1, wherein the attribute-based encryption comprises ciphertext-policy attribute-based encryption.

5. The data provider (1) according to claim 1, wherein the license issuer (3) is arranged for including a representation of the access policy (21) in the license (17).

6. The data provider (1) according to claim 1, further comprising a key generator (7) for generating a private key associated with a subset of the plurality of attributes.

7. A data receiver (10) for use in a digital rights management system, comprising
a data access subsystem (11) for accessing data, using attribute-based decryption, in dependence on a decryption key (16) associated with a set of attributes; and
a usage-constraining subsystem (12) for constraining the access to the data (20), based on a license (17) comprising a representation of a set of usage rights (18) associated (19) with the data.

8. The data receiver (10) according to claim 7, wherein the data (20) comprises content, and the data access subsystem (11) comprises
a key decrypter (13) for decrypting an encrypted representation of a content key, using attribute-based decryption, to obtain a decrypted content key; and
a content decrypter (14) for decrypting the content based on the decrypted representation of the content key.

9. The system according to claim 7, wherein the data access subsystem (11) comprises a data decrypter (15) for decrypting the data (20), using the attribute-based decryption.

10. A digital rights management system, comprising the data provider (1) according to claim 1 and the data receiver (10) comprising:
a data access subsystem (11) for accessing data, using attribute-based decryption, in dependence on a decryption key (16) associated with a set of attributes; and
a usage-constraining subsystem (12) for constraining the access to the data (20), based on a license (17) comprising a representation of a set of usage rights (18) associated (19) with the data.

11. A license (17) for use in a digital rights management system according to claim. 10, comprising a representation of a set of usage rights (18), and an association. (19) of the set of usage rights with data (20) protected using attribute-based encryption in dependence on an access policy over a set of attributes.

12. A computer system comprising a data receiver (10) according to claim 7, for accessing personal health records provided by a data provider (1), said data provider comprising:
a data protector (2) for protecting data (20), using attribute-based encryption, in dependence on an access policy over a plurality of attributes; and
a license issuer (3) for issuing a license (17) comprising a representation of a set of usage rights (18), wherein the set of usage rights (18) is associated (19) with the data (20), for granting the usage rights (18) in respect of the data (20) to a plurality of entities (10) having attributes satisfying the access policy.

13. A method of providing data for use in a digital rights management system, comprising
protecting (201) data, using attribute-based encryption, in dependence on an access policy over a plurality of attributes; and
issuing (202) a license comprising a representation of a set of usage rights, wherein the set of usage rights is associated with the data, for granting the usage rights in respect of the data to a plurality of entities having attributes satisfying the access policy.

14. A method of receiving data for use in a digital rights management system, comprising
accessing (301) data, using attribute-based decryption, in dependence on a decryption key associated with a set of attributes; and
constraining (302) the access to at least part of the data, based on a license comprising a representation of a set of usage rights associated with the data.

15. A computer program product comprising computer-readable instructions for causing a processor system to perform the method according to claim 13.
